(19) United States
(12) Patent Application Publication
(10) Pub. No.: US 2008/0263853 A1
(43) Pub. Date: Oct. 30, 2008

(54) 3C FRAME MANUFACTURING METHOD

(75) Inventors: TSUNG-HSUN TSAI, Taipei (TW); Chi-Wah Keong, Kaohsiung (TW); Bo-Yu Hung, Renwu Township (TW)

Correspondence Address: ERIC CHAN, 42 PIN OAKS DRIVE, PHOENIXVILLE, PA, 19460, US

(73) Assignees: CHENG FWA INDUSTRIAL CO., LTD., SANCHUNG CITY (TW); METAL INDUSTRIES RESEARCH & DEVELOPMENT CENTRE, KAOHSIUNG (TW)

(21) Appl. No.: 11/740,299

(22) Filed: Apr. 26, 2007

(51) Int. Cl. B23P 17/04

(52) U.S. Cl. 29/592

(57) ABSTRACT

A 3C frame manufacturing method including materials feeding, punching, coating, lapping, and curing processes provides a top quality technical production features of the present invention while avoiding problems of paint peeling or corrosion found with the conventional welding process; and allowing automated production, optimal use of human resources, significantly reduction of manual and labor costs, and shortening of production flow.

### BACKGROUND OF THE INVENTION

The present invention is related to a method for manufacturing a frame, and more particularly, to one for manufacturing a 3C frame by gluing a punched frame in conjunction with joints.

Most of conventional 3C frames are usually made of having an entire sheet of material punched into multiple side frames, and those side frames, typically four pieces of side frames, are then welded into a frame using resistance spot welding, laser welding or base welding method. However, the punching and welding processes are found with the following flaws:

1. Extreme waste of material to fail economic benefits since the entire sheet of material is punched while removing or hollowing the central portion.

2. The following disadvantages since the welding job is provided after multiple side frames are punched into shape:
a. The welding job is only made possible for the same type of metal;
b. Surface treatment of the frame can be done after the completion of the welding job since the welding job becomes very difficult and results in damaged coating layer at where the welding job is provided to further invite rust corrosion if the welding job is provided after the coating process;
c. The welding job will lease marks on the frame to compromise appearance and quality of the finished product;
d. The frame is vulnerable to thermal deformation or poor surface level due to the welding job provided to increase time and labor costs warranted by correction;
e. Multiple spots must be welded to further increase production cost;
f. It is very expensive to have and maintain a laser welding system while the costs to have and maintain resistance spot welding and base welding are also comparatively higher;
g. Complicate design of jigs to weld fasteners and lengthy time consumed in welding those fasteners reduce production capacity; and
h. Long-term optical hazards and spurting accompanying the welding job cause harms to the environment and human health.

### BRIEF SUMMARY OF THE INVENTION

The primary purpose of the present invention is to provide a manufacturing method for a 3C frame that allows cost reduction, automated production, and reduced reliance upon labor force.

The secondary purpose of the present invention is to provide a manufacturing method for a 3C frame that saves material costs by overcoming the problem of material waste found with the prior art when the core of the material must be removed in the punching process.

The thirdly purpose of the present invention is to provide a manufacturing method for a 3C frame that is environment friendly so to minimize hazards to human body, environment or work safety issues.

The fourth purpose of the present invention is to provide a manufacturing method for a 3C frame that permits surface treatment (e.g., galvanization, painting or coating) before gluing to secure where lapping takes place to avoid stripping coating layer off or corrosion at joint of resistance spot welding or base welding.

The fifth purpose of the present invention is to provide a manufacturing method for a 3C frame that prevents the defects including deformation resulted from the welding process found with the prior art.

The sixth purpose of the present invention is to provide a manufacturing method for a 3C frame that allows its finished product to yield high shear strength and high bond tenacity.

The seventh purpose of the present invention is to provide a manufacturing method for a 3C frame that saves production cost by using summary design of fixtures and clamps.

The eighths purpose of the present invention is to provide a manufacturing method for a 3C frame that allows connection between different natures of materials to give much more flexibility of design than that does by the prior art.

To achieve those purposes, the present invention includes materials feeding, punching, coating, lapping, and curing processes for the production of a 3C frame. Top quality technical production features of the present invention while avoiding problems of paint peeling or corrosion found with the conventional welding process allows automated production, optimal use of human resources, significantly reduction of manual and labor costs, and shortening of production flow.

### BRIEF DESCRIPTION OF THE DRAWINGS

FIG. 1 is a schematic view showing a process flow of the present invention.

FIG. 2 is an exploded view showing a product of a first preferred embodiment of the present invention.

FIG. 3 is a perspective view showing the product as assembled of a first preferred embodiment of the present invention.

FIG. 4 is an exploded view showing a product of a second preferred embodiment of the present invention.

FIG. 5 is an exploded view showing a product of a third preferred embodiment of the present invention.

FIG. 6 is a perspective view showing the product as assembled of the second preferred embodiment of the present invention.

FIG. 7 is an analysis chart of mechanical performance test conducted on a product processed using the present invention.

FIG. 8 is another analysis chart of mechanical performance test conducted on a product processed using the present invention.

### DETAILED DESCRIPTION OF THE INVENTION

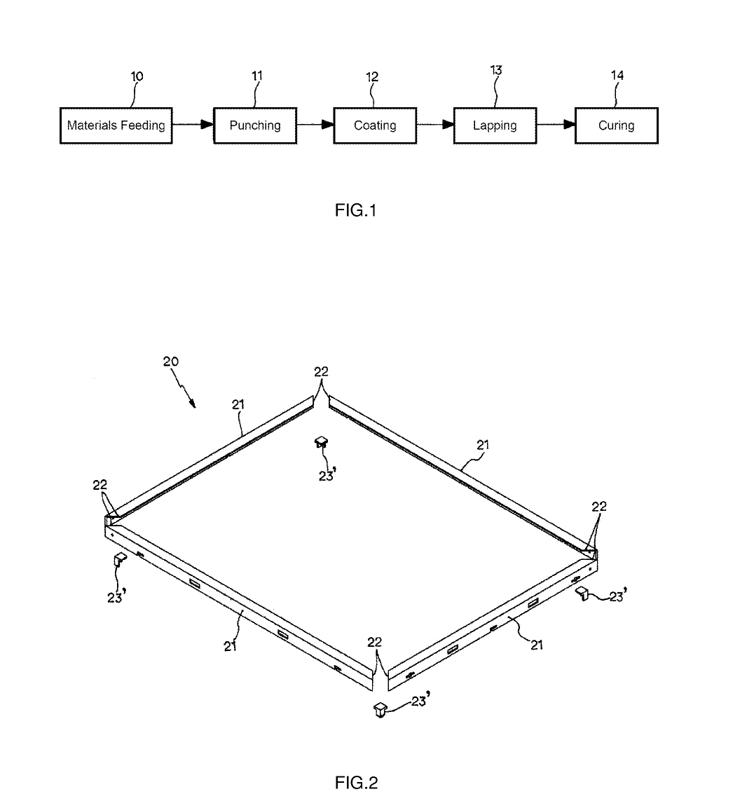

Referring to FIG. 1, a manufacturing method for a 3C frame includes the following processes: a feeding process 10, a punching process 11, a coating process 12, a lapping process 13, and a curing process 14.

In the feeding process 10, a material related to a ferrous metal or a non-ferrous metal is fed as the material for formation of a 3C frame; the ferrous metal allows its surface to be plated with zinc, hot-dip galvanized, or other surface treatment; and the non-ferrous metal is related to aluminum alloy or magnesium alloy.

The punching process 11 is executed in one or multiple of following courses: stamping, forming, and banding; wherein the material fed is punched into a L-shaped side frame 21 or a straight side frame 21; both ends of each side frame 21 are respectively disposed with a lapping portion 22; and it is preferred that a joint 23 is formed at one or a plurality of the lapping portion 22 on the side frame 21; the joint 23 is lapped over the lapping portion 22 or the joint 23 on the other side frame 21 to form a structure of a frame 20; or alternatively, a lapping member 23′ is provided to lap over the lapping portions 22 of two adjacent side frames 21 to achieve the same purpose of completing a structure of the frame 20.

An adhesive is applied on each lapping portion 22, each joint 23 formed at the lapping portion 22 or each lapping member 23′ in the coating process 12; and the adhesive is related to one dedicate to a structure of high shear strength and high bond strength, e.g., an epoxy or acrylic adhesive; or an environment friendly adhesive below the level of limited use set forth by EU RoHS.

During the lapping process 13, multiple side frames 21 are assembled by lapping the lapping portion 22, the joint 23 or the lapping member 23′ over each other for each side frame 21; and it is preferred that a clamp or a fixture is provided to secure the lapping portion 22, the joint 23 or the lapping member 23′ to ensure all side frames 21 are firmly lapped over one another.

Finally, in the curing process 14, the adhesive is cured for the frame 20 to take shape; and to shorten the time frame of curing, the curing process 14 is done in an oven at a temperature falling within a range of 150˜190° C. and a time frame between 10˜30 minutes.

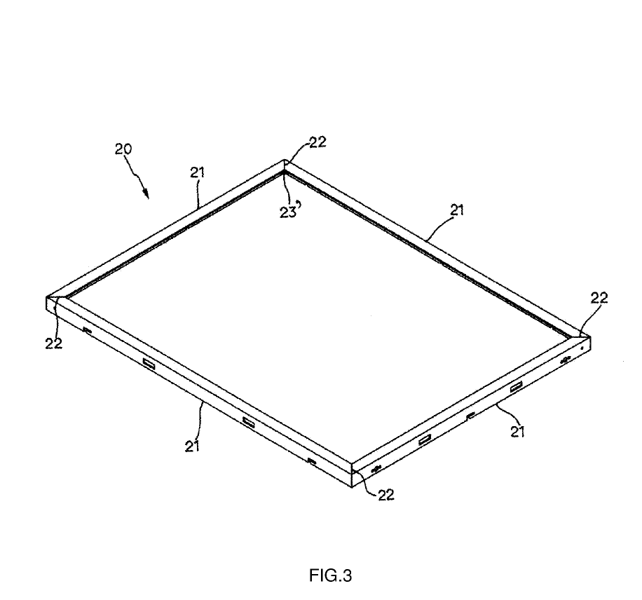

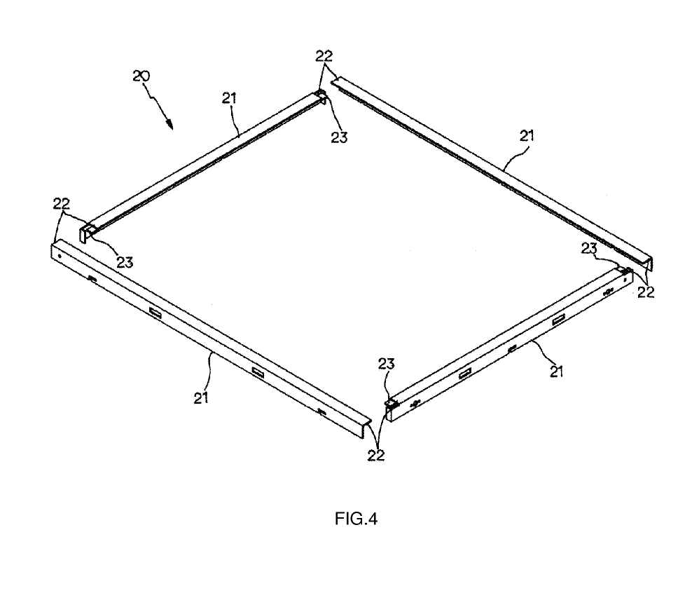

Now referring to FIGS. 2 and 3, four straight side frames 21 are formed during the punching process 11 and each pair of lapping portions 22 on two adjacent side frames 21 is disposed with the lapping member 23′ to lap over each other for taking shape of the structure of the frame 20.

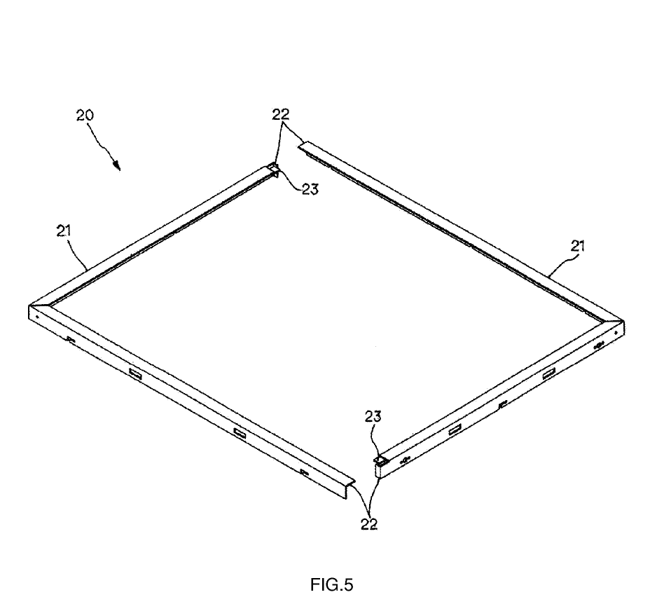

As illustrated in FIGS. 4 and 6, four straight side frames 21 are formed during the punching process 11 and each lapping portion 22 on the side frame 21 is disposed with the joint 23 for four side frames 21 to lap over one another for taking shape of the structure of the frame 20.

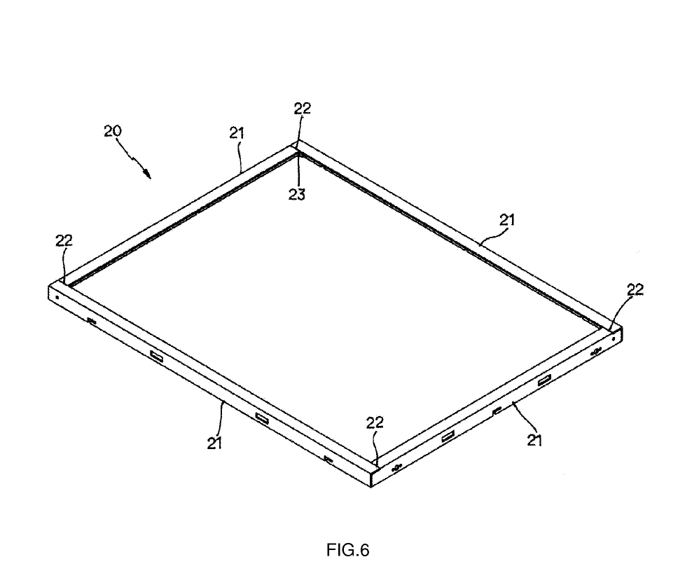

Alternatively, as illustrated in FIG. 5, a pair of L-shaped side frames 21 are formed during the punching process 11, and the joint 23 is disposed at each lapping portion 22 on both side frame 21 to lap over each other for taking shape of the structure of the frame 20.

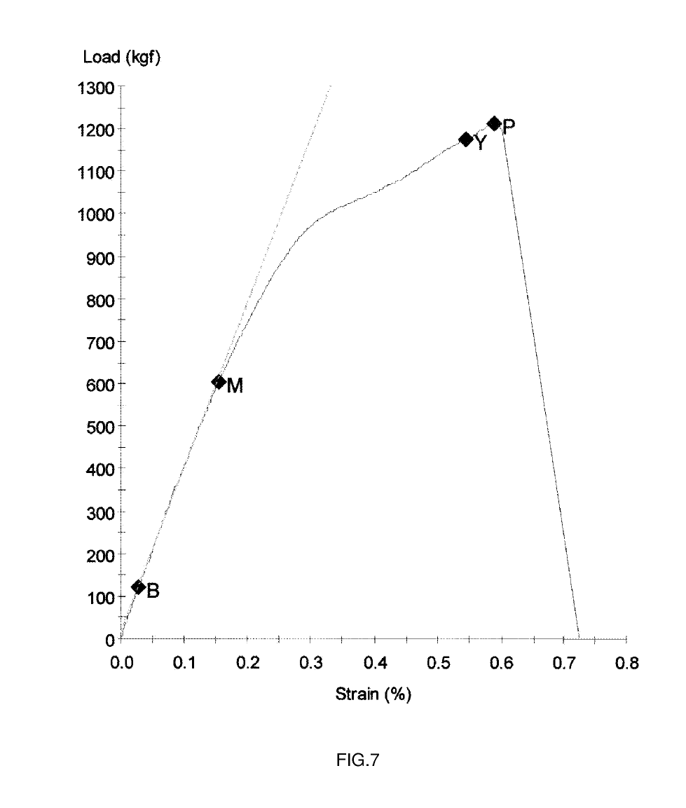

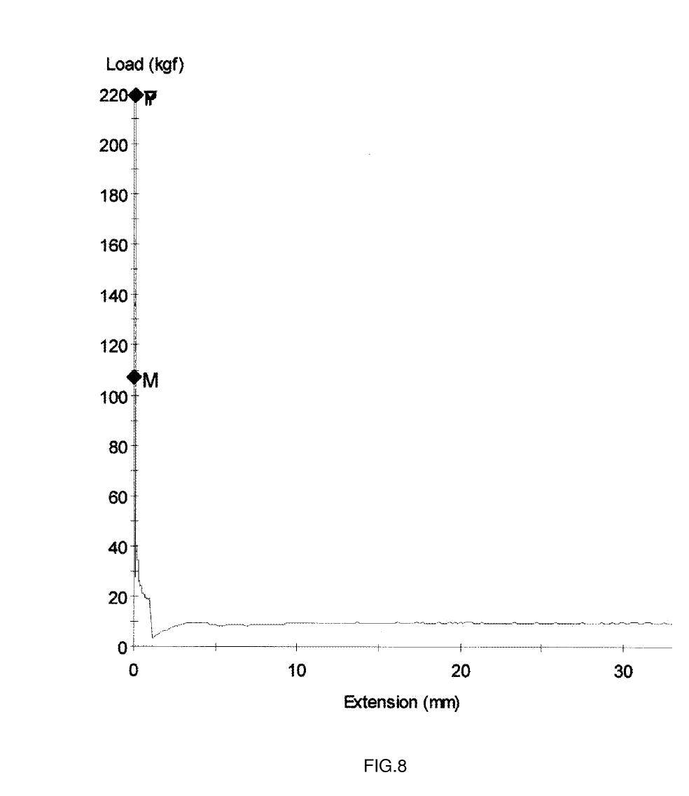

As illustrated in FIGS. 7 and 8 showing results of shear strength and peeling strength conducted on the frame 20 of the present invention through tests of adhesion and mechanical property of the adhesive, mainly in the shear strength and peeling strength tests, the shear strength is as high as 350 kgf/cm² and the peak peeling strength reaches 800N/cm (i.e., 2000N of peeling peak load) indicating the present invention yields high adhesion strength and bond tenacity, much higher than that of resistance spot welding and conventional welding process, to provide more flexible and comprehensive applications.

The present invention discloses an inventive step of 3C frame top quality manufacturing skill that provides multiple advantages including allowing the execution of the coating process before gluing to achieve free of welding marks at the joint and to prevent from problems of paint stripping off and rust corrosion due to welding for significantly shortening production flow while helping environmental production, reducing consumption of material resources and hazards to human health, thus to further achieve automated production and optimal use of human resources by massive reduction of reliance and costs on labor force.

Accordingly, purposes of a 3C frame manufacturing method of the present invention can be realized by the structure disclosed above; and the present invention has never been published or allowing the public to use before its filing date meets patentability elements of novelty and progressiveness.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A 3C frame manufacturing method including a feeding process to feed material of the frame; a punching process to punch the material into multiple side frames with each having both ends respectively disposed with a lapping portion; a coating process to coat an adhesive at each lapping portion, a lapping process to fabricate multiple side frames into the frame by lapping over those side frames at their lapping portions; and a curing process to cure the adhesive for the frame to take shape.

2. The 3C frame manufacturing method as claimed in claim 1, wherein the material is ferrous or non-ferrous metal.

3. The 3C frame manufacturing method as claimed in claim 1, wherein the material permits surface treatment.

4. The 3C frame manufacturing method as claimed in claim 2, wherein the material permits surface treatment.

5. The 3C frame manufacturing method as claimed in claim 1, wherein the material is punched into straight side frames or L-shaped side frames.

6. The 3C frame manufacturing method as claimed in claim 1, wherein the adhesive is one of high shear strength and high peeling strength for the frame structure.

7. The 3C frame manufacturing method as claimed in claim 6, wherein the adhesive relates to an epoxy or acrylic adhesive, or to an environment friendly adhesive below the level of limited use set forth by EU RoHS.

8. The 3C frame manufacturing method as claimed in claim 1, wherein a joint is disposed at one or a multiple lapping portion of the side frame to lap over another side frame.

9. The 3C frame manufacturing method as claimed in claim 1, wherein at least one lapping member is disposed for lapping over the lapping portions of two adjacent side frames for the frame to take shape.

10. The 3C frame manufacturing method as claimed in claim 1, wherein the curing process is done in an oven.

11. The 3C frame manufacturing method as claimed in claim 1, wherein the curing temperature falls within a range of 150˜190° C. for a time frame of 10˜30 minutes.

12. The 3C frame manufacturing method as claimed in claim 10, wherein the curing temperature falls within a range of 150˜190° C. for a time frame of 10˜30 minutes.

13. The 3C frame manufacturing method as claimed in claim 1, wherein each side frame is secured by means of a clamp or a fixture at the lapping portion during the lapping process.

14. The 3C frame manufacturing method as claimed in claim 8, wherein each side frame is secured by means of a clamp or a fixture at the joint during the lapping process.

15. The 3C frame manufacturing method as claimed in claim 9, wherein each side frame is secured by means of a clamp or a fixture at the lapping member during the lapping process.
